(19) United States
(12) Patent Application Publication
(10) Pub. No.: US 2025/0304740 A1
(43) Pub. Date: Oct. 2, 2025

(54) METHOD OF FAST CURING A POLYTHIOURETHANE BASED SUBSTRATE USING A DELAYED-ACTION CATALYST

(71) Applicant: Essilor International, Charenton-le-Pont (FR)

(72) Inventor: Pierre FROMENTIN, Bangkok (TH)

(21) Appl. No.: 18/874,367

(22) PCT Filed: Jun. 30, 2023
(86) PCT No.: PCT/EP2023/068093

§ 371 Date: Dec. 12, 2024

(30) Foreign Application Priority Data
Jun. 30, 2022 (EP) 22305961.9

(51) Int. Cl. C08G 18/10; C08G 18/20; C08G 18/64; C08G 18/80; G02C 7/02

(52) U.S. Cl. CPC C08G 18/10; C08G 18/2063; C08G 18/2072; C08G 18/6453; C08G 18/8054; G02C 7/02

(57) ABSTRACT

The present invention relates to a method of fast curing a polythiourethane based transparent casted substrate. comprising in a preferred embodiment providing a first component A comprising a polythiourethane pre-polymer Al having isocyanate or isothiocyanate end groups. providing a second component B comprising a polythiourethane pre-polymer BI having thiol end groups. mixing together first and second components A and B and filling a molding cavity of a casting mold assembly with the resulting mixture. curing said mixture to obtain a transparent substrate, wherein at least one latent catalyst that is heat-activatable is added in the process prior to curing step 4). and said catalyst is subsequently activated to accelerate the polymerization reaction forming the polythiourethane based transparent substrate.

The present invention relates to a process for manufacturing polythiourethane based substrates, and in particular optical substrates such as ophthalmic lenses, having generally a middle or high refractive index, preferably of at least 1.52, more preferably of at least 1.54, more preferably of at least 1.6 and even more preferably of at least 1.67, within short curing cycles.

### BACKGROUND AND SUMMARY OF THE INVENTION

Ophthalmic lenses made of polythiourethane based substrates are typically made by a process comprising mixing appropriate monomers in a tank, such as a mixture of a polyisocyanate and a polythiol, adding catalyst and additive, filling a molding cavity with this liquid mixture of monomers, polymerizing the monomer mixture and thereafter recovering the polymerized polythiourethane based substrate from the mold. The mixture is usually subjected to a thermal cycle in an oven, for a typical duration of 20 hours. A fast cure process is highly desirable over usual process as the shorter residence time in curing oven enables a dramatic productivity gain, complex and demanding lens geometries can be obtained in better yield as the final polymerizable mixture shrinkage is lower than that of mixture obtained directly from monomers, compatibility with the adhesive of tape used for mold assembly is better, and energy consumption during polymerization cycles is reduced.

It is known to reduce the time required to cure the polymerizable composition poured into mold assemblies by using oligomers rather than monomers. The monomers are first pre-reacted to form oligomers, then blended with a catalyst that provide a high overall reactivity in very small volume or even through in-line mixing equipment, then poured into mold assemblies that are subjected to a short polymerization cycle, typically few hours.

In this regard, US 2003/125410 discloses a method of fast curing polythiourethane transparent casted substrate, which comprises the steps of:
1) Providing a first component A comprising a polythiourethane pre-polymer having isocyanate or isothiocyanate end groups,
2) Providing a second component B comprising a polythiourethane pre-polymer having thiol end groups,
3) Mixing together first and second components A and B and filling a molding cavity of a casting mold assembly with the resulting mixture,
4) Curing said mixture to obtain a transparent solid substrate, in the presence of a highly reactive catalyst to dramatically shorten the curing time of the polymerizable composition within typically 2 hours.

Provided that the viscosity is controlled, batch mixing of such mixtures is inherently safer than usual process from monomers, as part of the available bond forming energy has already been released during the oligomers formation (pre-polymerization), which limits formation of local heat points in the final polymerizable mixture. The use of pre-polymers allows stable and steady reaction. Known catalysts for polythiourethane synthesis are dibutyltin dichloride or a mixture of KSCN and 18-crown-6. However, when all ingredients are mixed together, they will react and form a gel at room temperature in less than 10 minutes.

In applications EP 3916470 and EP 3919967, a different approach for fast curing a polythiourethane optical material has been chosen, combining the use of monomers and pre-polymers in the presence of a polymerization catalyst, typically a basic catalyst.

However, a major technical problem of the fast cure process described in the prior art is the short pot life of the polymerizable mixture, leading to a huge constraint on mixing/filing step as only a short time is allowed to achieve highly intimate mixing of very viscous pre-polymers before gelling. A polymerizable mixture having a longer pot life, e.g., a longer time range before reaching a viscosity where it is not anymore handlable (mixing/filing) would thus be a great advantage to extend mixing time, especially critical as the mixture is highly viscous. In addition, such a mixture could be advantageously processed in batches, similarly to the usual process starting from monomers.

Thus, the aim of the present invention is to provide a method of fast curing a polythiourethane based transparent casted substrate which remedies to the drawbacks of the prior art methods in terms of reduced pot life of the polymerizable mixture.

Another object of the invention is to provide a method of fast curing polythiourethane based transparent casted substrates substantially free from optical defects, in particular free from bubbles and/or striations resulting from the polymerization process.

The present inventors found that the reactivity of the polymerizable mixture could be minimized by using specific catalysts that are blended under an inactive form and display essentially no catalytic effect in the polymerizable mixture, while being subsequently triggered to form the final polythiourethane based polymer. These catalysts allow a better control of the polymerization reaction.

The present invention provides a method of fast curing a polythiourethane based transparent casted substrate, usable for making optical articles such as ophthalmic lenses, which comprises the steps of:
1) Providing from at least one polythiol monomer and at least one polyisocyanate or polyisothiocyanate monomer a first component A comprising a polythiourethane pre-polymer A1 having isocyanate or isothiocyanate end groups of formula —NCX where X is O or S,
2) Providing from at least one polythiol monomer and at least one polyisocyanate or polyisothiocyanate monomer a second component B comprising a polythiourethane pre-polymer B1 having thiol end groups, or:
1) Providing a first component A comprising at least one polyisocyanate or polyisothiocyanate monomer,
2) Providing from polythiol and polyisocyanate or polyisothiocyanate monomers a second component B comprising a polythiourethane pre-polymer B1 having thiol end groups, or:
1) Providing from polythiol and polyisocyanate or polyisothiocyanate monomers a first component A comprising a polythiourethane pre-polymer A1 having isocyanate or isothiocyanate end groups of formula —NCX where X is O or S,
2) Providing a second component B comprising at least one polythiol monomer,
3) Mixing together first and second components A and B and filling a molding cavity of a casting mold assembly with the resulting mixture,
4) Curing said mixture to obtain a polythiourethane based transparent substrate, and
5) Recovering the polythiourethane based transparent substrate from the casting mold assembly,
wherein at least one latent catalyst that is heat-activatable is used in the process prior to curing step 4), and said catalyst is subsequently activated.

In the present invention, at least one latent catalyst that is heat-activatable is added in the process prior to curing step 4), and said catalyst is subsequently activated to accelerate the polymerization reaction forming the polythiourethane based transparent substrate.

The present process offers several advantages in addition to those mentioned above.

The reactivity of the finally formulated polymerizable mixture is essentially the same as that of an uncatalyzed blend, and it can be flowed through pipe to filing stations with less risks of clogging from local gelling.

All components can be admixed together, including the catalyst, over a period of time that is compatible with a very high level of mixing state, reducing inhomogeneities and optical defects likeliness such as striations.

### DETAILED DESCRIPTION OF THE INVENTION

The substrate of the invention is an organic glass substrate, made from a thermosetting resin. The polymer matrix of substrate is obtained from a material composition (“substrate composition”) comprising at least one polymerizable pre-polymers, preferably at least two.

The substrate is preferably an optical article substrate, more preferably an optical lens substrate. The optical article is preferably an ophthalmic lens, such as a plastic eyeglass lens.

In the present description, unless otherwise specified, a substrate is understood to be transparent when the observation of an image through said substrate is perceived with no significant loss of contrast, that is, when the formation of an image through said substrate is obtained without adversely affecting the quality of the image. This definition of the term “transparent” can be applied to all objects qualified as such in the description, unless otherwise specified.

The term “ophthalmic lens” is used to mean a lens adapted to a spectacle frame to protect the eye and/or correct the sight. Said lens can be chosen from afocal, unifocal, bifocal, trifocal, progressive lenses and Fresnel lenses or any other kind of lenses having a discontinuous surface. Although ophthalmic optics is a preferred field of the invention, it will be understood that this invention can be applied to optical elements of other types such as, for example, lenses for optical instruments, filters particularly for photography or astronomy, optical sighting lenses, ocular visors, optics of lighting systems, screens, glazings, etc.

If the optical article is an optical lens, it may be coated on its front main surface, rear main side, or both sides with one or more functional coatings. As used herein, the rear face of the substrate is intended to mean the face which, when using the article, is the nearest from the wearer's eye. It is generally a concave face. On the contrary, the front face of the substrate is the face which, when using the article, is the most distant from the wearer's eye. It is generally a convex face. The optical article can also be a plano article.

A substrate, in the sense of the present invention, should be understood to mean an uncoated substrate, and generally has two main faces. The substrate may in particular be an optically transparent material having the shape of an optical article, for example an ophthalmic lens destined to be mounted in glasses. In this context, the term “substrate” is understood to mean the base constituent material of the optical lens and more particularly of the ophthalmic lens. This material may act as support for a stack of one or more coatings or layers.

The refractive index of the polythiourethane based transparent substrate is preferably 1.52 or greater, more preferably 1.54 or greater, more preferably 1.56 or greater, more preferably 1.58 or greater, more preferably 1.60 or greater, and still more preferably 1.65 or greater, and it is preferably 1.80 or less, more preferably 1.70 or less, and still more preferably 1.67 or less. Unless otherwise specified, the refractive indexes referred to in the present application are expressed at 25° C. at a wavelength of 550 nm.

The fast cure polymerizable composition leading to a polythiourethane based material is composed of two main components.

In a first embodiment of the invention, the first component A is comprised of a polythiourethane pre-polymer A1 having isocyanate (NCO) or isothiocyanate (NCS) end groups. The second component B is comprised of a polythiourethane pre-polymer B1 having thiol (SH) end groups.

In step 1) of the first and third embodiments of present process, a first component A comprising a polythiourethane pre-polymer A1 having isocyanate or isothiocyanate end groups is provided and has been prepared from at least one polythiol monomer and at least one polyisocyanate or polyisothiocyanate monomer, the latter being used in excess. The first component A comprises therefore oligomers and the initial monomers that did not polymerize.

In step 2) of the first and second embodiments of present process, a second component B comprising a polythiourethane pre-polymer B1 having thiol end groups is provided and has been prepared from at least one polythiol monomer and at least one polyisocyanate or polyisothiocyanate monomer, the former being used in excess. The second component B comprises therefore oligomers and the initial monomers that did not polymerize.

In a second embodiment of the invention, the first component A is comprised of at least one polyisocyanate or polyisothiocyanate monomer. The second component B is comprised of a polythiourethane pre-polymer B1 having thiol (SH) end groups.

In a third embodiment of the invention, the first component A is comprised of a polythiourethane pre-polymer A1 having isocyanate (NCO) or isothiocyanate (NCS) end groups. The second component B is comprised of at least one polythiol monomer.

Compared to prior art processes which use only iso(thio)cyanate or thiol monomers, the present invention uses at least one pre-polymer.

By pre-polymer, it is meant a polymer or oligomer comprising pre-polymer molecules. By pre-polymer molecule, it is meant a macromolecule or oligomer molecule capable of entering, through reactive (polymerizable) groups, into further polymerization, thereby contributing more than one monomeric unit to at least one chain of the final macromolecule. It is generally formed from two or more different monomers.

The polythiourethane pre-polymer A1 having isocyanate or isothiocyanate end groups is prepared by reacting at least one polyisocyanate or polyisothiocyanate monomer and at least one polythiol monomer in a proportion such that the molar ratio of isocyanate or isothiocyanate groups to thiol groups NCX/SH preferably ranges from 3:1 to 30:1, preferably in the absence of a catalyst, X being O or S.

The polythiourethane pre-polymer B1 having thiol end groups is prepared by reacting at least one polyisocyanate or polyisothiocyanate monomer and at least one polythiol monomer in a proportion such that the molar ratio of the thiol groups to the isocyanate or isothiocyanate groups SH/NCX preferably ranges from 3:1 to 30:1, preferably in the absence of a catalyst, X being O or S.

Polythiol and polyisocyanate or polyisothiocyanate compounds used to prepare polythiourethane pre-polymer A1 or B1 are considered herein as monomers, even when they are oligomers.

By polyisocyanate, it is meant any compound comprising at least two isocyanate groups, in other words diisocyanates, triisocyanates, etc. Polyisocyanate pre-polymers may be used. The polyisocyanate may be any suitable polyisocyanate having two or more, preferably two or three isocyanate functions.

The polyisocyanates may be selected from aliphatic, aromatic, cycloaliphatic or heterocyclic polyisocyanates and mixtures thereof.

Polyisothiocyanate are defined in the same manner as polyisocyanates above, by replacing the “isocyanate” group by the “isothiocyanate” group.

The preferred polyisocyanate or isothiocyanate monomers are those having the formulae:

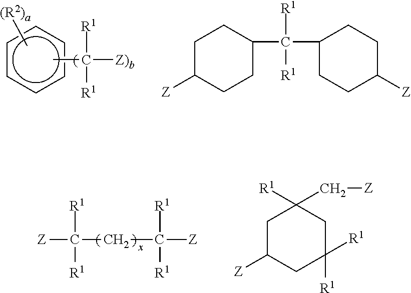

wherein R¹ is independently H or a C₁-C₅ alkyl group, preferably CH₃ or C₂H₅;
R² is H, a halogen, preferably Cl or Br, or a C₁-C₅ alkyl group, preferably CH₃ or C₂H₅;
Z is —N═C═X, with X being O or S, preferably O;
a is an integer ranging from 1 to 4, b is an integer ranging from 2 to 4 and a+b≤6; and
x is an integer from 1 to 10, preferably 1 to 6.

The polyisocyanates of the invention are preferably diisocyanates. Among the available diisocyanates may be cited toluene-2,4-diisocyanate, toluene-2,6-diisocyanate, diphenylmethane-4,4′-diisocyanate, diphenylmethane-2,4′-diisocyanate, paraphenylene diisocyanate, xylylene diisocyanate, biphenyl-diisocyanate, 3,3′-dimethyl-4,4′-diphenylene diisocyanate, tetramethylene-1,4-diisocyanate, hexamethylene-1,6-diisocyanate, 2,2,4-trimethyl hexane-1,6-diisocyanate, lysine methyl ester diisocyanate, bis(isocyanatoethyl) fumarate, isophorone diisocyanate (IPDI), ethylene diisocyanate, dodecane-1, 12-diisocyanate, cyclobutane-1,3-diisocyanate, cyclohexane-1,3-diisocyanate, cyclohexane-1,4-diisocyanate, methylcyclohexyl diisocyanate, hexahydrotoluene-2,4-diisocyanate, hexahydrotoluene-2,6-diisocyanate, hexahydrophenylene-1,3-diisocyanate, hexahydrophenylene-1,4-diisocyanate, perhydro diphenylmethane-2,4′-diisocyanate, perhydro phenylmethane-4,4′-diisocyanate (or bis-(4-isocyanatocyclohexyl)-methane, or 4,4′-dicyclohexylmethanediisocyanate), bis(isocyanatomethyl) cyclohexane, dicyclohexylmethane diisocyanate, 2,5 (or 2,6)-bis (isocyanatomethyl) bicyclo-[2.2.1]-heptane, and their mixtures.

Other non-limiting examples of polyisocyanates are the isocyanurates from isophorone diisocyanate and 1,6-hexamethylene diisocyanate, both of which are commercially available. Further polyisocyanates suitable for the present invention are described in detail in WO 98/37115, WO 2014/133111 or EP 1877839.

The polythiols that may be used in the present invention are defined as compounds comprising at least two sulfhydryl (mercapto) groups, in other words dithiols, trithiols, tetrathiols etc. Polythiols pre-polymers may be used. The polythiol may be any suitable polythiol having two or more, preferably two or three thiol functions.

Among the preferred polythiol monomers and/or oligomers suitable in accordance with the present invention, there may be cited aliphatic polythiols such as trimethylolpropanetris(2-mercaptoacetate), trimethylolpropanetris(3-mercaptopropionate), trimethylolethanetris(2-mercaptoacetate), trimethylolethanetris(3-mercaptopropionate), pentaerythritol tetrakis(2-mercaptoacetate), pentaerythritol tetrakis(3-mercaptopropionate), bis(mercaptomethyl)sulfide, bis(mercaptomethyl)disulfide, bis(mercaptoethyl)sulfide, bis(mercaptoethyl)disulfide, bis(mercaptopropyl)sulfide, bis(mercaptopropyl)disulfide, 2,3-bis((2-mercaptoethyl) thio)-1-propanethiol, 4,8 (or 4,7 or 5,7)-dimercaptomethyl-1,11-dimercapto-3,6,9-trithiaundecane, 2,5-dimercaptomethyl-1,4-dithiane, and 2,5-bis[(2-mercaptoethyl)thiomethyl]-1,4-dithiane, 1-(1′-mercaptoethylthio)-2,3-dimercaptopropane, 1-(2′-mercapropylthio)-2,3-dimercaptopropane, 1-(3′-mercapropylthio)-2,3-dimercaptopropane, 1-(4′-mercabutylthio)-2,3-dimercaptopropane, 1-(5′-mercapentylthio)-2,3-dimercaptopropane, 1-(6′-mercahexylthio)-2,3-dimercaptopropane, 1,2-bis-(4′-mercaptobutylthio)-3-mercaptopropane, 1,2-bis-(5′-mercaptopentylthio)-3-mercaptopropane, 1,2-bis-(6′-mercaptohexylthio)-3-mercaptopropane, 1,2,3-tris(mercaptomethylthio)propane, 1,2,3-tris-(3′-mercaptopropylthio)propane, 1,2,3-tris-(2′-mercaptoethylthio) propane, 1,2,3-tris-(4′-mercaptobutylthio)propane, 1,2,3-tris-(6′-mercaptohexylthio)propane, methanedithiol, 1,2-ethanedithiol, 1,1-propanedithiol, 1,2-propanedithiol, 1,3-propanedithiol, 2,2-propanedithiol, 1,6-hexanethiol-1,2,3-propanetrithiol, and 1,2-bis(2′-mercaptoethylthio)-3-mercaptopropane. Further examples of polythiols are shown in the formulae below or can be found in WO 2014/133111, EP 394495, U.S. Pat. No. 4,775,733 or EP 1877839:

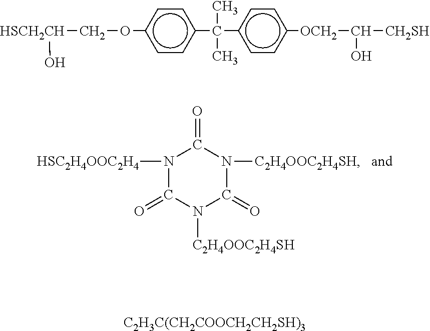

Preferred embodiments are combination of xylylene diisocyanate and pentaerythritol tetrakis(3-mercaptopropionate); combination of xylylene diisocyanate and 2,3-bis((2-mercaptoethyl)thio)-1-propanethiol; combination of 2,5 (or 2,6)-bis(isocyanatomethyl)bicyclo-[2.2.1]-heptane, pentaerythritol tetrakis(3-mercaptopropionate) and 2,3-bis((2-mercaptoethyl) thio)-1-propanethiol; combination of xylylene diisocyanate and 4,8 (or 4,7 or 5,7)-dimercaptomethyl-1,11-dimercapto-3,6,9-trithiaundecane; combination of dicyclohexylmethane diisocyanate and 4,8 (or 4,7 or 5,7)-dimercaptomethyl-1,11-dimercapto-3,6,9-trithiaundecane; or a combination of bis(2,3-epithiopropyl)disulfide and 4,8 (or 4,7 or 5,7)-dimercaptomethyl-1,11-dimercapto-3,6,9-trithiaundecane. The most preferred polythiol is 2,3-bis((2-mercaptoethyl)thio)-1-propanethiol, shown below:

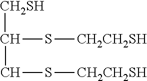

Preferably the polythiols have a viscosity at 25° C. of 1 Pa·s or less, more preferably 5.10⁻¹ Pa·s or less, more preferably 2.5.10⁻¹ Pa·s or less, more preferably 2.10⁻¹ Pa·s or less, more preferably 10⁻¹ Pa·s or less and even more preferably of 0.5.10⁻¹ Pa·s or less.

Depending on the embodiment of the invention, components A and B are prepared by polymerizing mixtures of required amounts of at least one polyisocyanate and/or at least one polyisothiocyanate monomer and at least one polythiol monomer, and optionally polyols monomers or polyamines monomers. Typically, components A and B can be prepared through classical thermal polymerization including induction and infrared heating.

The amounts of polyisocyanate or polyisothiocyanate monomers and polythiol monomers in the reaction medium are preferably adapted in each case in such a way that the molar ratio of NCX/SH groups for the mixture of polyisocyanate or polyisothiocyanate monomers and polythiol monomers ranges from 3:1 to 30:1 for the preparation of polythiourethane pre-polymer A1, preferably from 6:1 to 10:1, and/or the molar ratio of SH/NCX groups for the mixture of polyisocyanate or polyisothiocyanate monomers and polythiol monomers ranges from 3:1 to 30:1 for the preparation of polythiourethane pre-polymer B1, preferably from 6:1 to 10:1, X being O or S.

In one embodiment, both components A and B are prepared without the use of a catalyst system, which allows better control of the polymerization reaction and results in pre-polymers of high stability in time. However, they can be prepared using a catalyst or catalyst system as described above.

Generally, in the first embodiment of the invention, the pre-polymer A1 and the pre-polymer B1 are comprised in the mixture in an amount such that the molar ratio of NCX to SH groups is from 0.8 to 1.2, preferably 1.

Generally, in the second embodiment of the invention, the at least one polyisocyanate or polyisothiocyanate monomer and the pre-polymer B1 are comprised in the mixture in an amount such that the molar ratio of NCX to SH groups is from 0.8 to 1.2, preferably 1.

Generally, in the third embodiment of the invention, the pre-polymer A1 and the at least one polythiol monomer are comprised in the mixture in an amount such that the molar ratio of NCX to SH groups is from 0.8 to 1.2, preferably 1.

Generally, in the second embodiment of the invention, the polyisocyanate or polyisothiocyanate of component A and the pre-polymer B1 are comprised in the mixture in an amount such that the molar ratio of NCX to SH groups is from 0.8 to 1.2, preferably 1.

Generally, in the third embodiment of the invention, the pre-polymer A1 and the polythiol of component B are comprised in the mixture in an amount such that the molar ratio of NCX to SH groups is from 0.8 to 1.2, preferably 1.

Preparation of pre-polymer B1 having thiol end groups has already been described in U.S. Pat. No. 5,908,876. Similar process can be used to prepare component B of the present invention.

When component A of the present invention comprises polythiourethane pre-polymer A1, it can be prepared in a similar manner but with the required ratio of polyisocyanate or polyisothiocyanate and polythiol monomers in order to obtain polythiourethane pre-polymer A1 having isocyanate or isothiocyanate end groups.

The mixture polythiol/polyiso(thio)cyanate from which pre-polymer A1 is obtained may comprise 90% or less by weight of at least one polyol. Preferably, said mixture may comprise 80% or less, 70% or less, 60% or less, 50% or less, 40% or less, 30% or less, 20% or less, 10% or less by weight of at least one polyol. Also preferably, no polyol is used. Polyiso(thio)cyanate means polyisocyanate or polyisothiocyanate.

The mixture polythiol/polyiso(thio)cyanate from which pre-polymer B1 is obtained may comprise 90% or less by weight of at least one polyol. Preferably, said mixture may comprise 80% or less, 70% or less, 60% or less, 50% or less, 40% or less, 30% or less, 20% or less, 10% or less by weight of at least one polyol. Also preferably, no polyol is used.

The mixture of components A and B according to the invention may also include additives which are conventionally employed in polymerizable compositions intended for moulding optical articles, in particular ophthalmic lenses, in conventional proportions, namely inhibitors, dyes, photochromic agents, UV absorbers, perfumes, deodorants, antioxidants, resin modifiers, color balancing agents, chain extenders, crosslinking agents, free radical scavengers such as antioxidants or hindered amine light stabilizers (HALS), dyes, pigments, fillers, adhesion accelerators, anti-yellowing agents and mold release agents.

In one embodiment, the additives are added to first component A prior to the mixing with second component B.

UV absorbers are frequently incorporated into optical articles in order to reduce or prevent UV light from reaching the retina (in particular in ophthalmic lens materials). The UV absorber that may be used in the present invention preferably have the ability to at least partially block light having a wavelength shorter than 400 nm, but can also have an absorption spectrum extending to the visible blue light range of the electromagnetic spectrum (400-450 nm), in particular 420-450 nm.

Said UV absorbers both protect the user's eye from UV light and the substrate material itself, thus preventing it from weathering and becoming brittle and/or yellow. The UV absorber according to the invention can be, without limitation, a benzophenone-based compound, a benzotriazole-based compound or a dibenzoylmethane-based compound, preferably a benzotriazole compound. Suitable UV absorbers include without limitation 2-(2-hydroxyphenyl)-benzotriazoles such as 2-(2-hydroxy-3-tert-butyl-5-methylphenyl)-5-chlorobenzotriazole (Seesorb® 703/Tinuvin® 326), or other allyl hydroxymethylphenyl chlorobenzotriazoles, 2-(5-chloro-2H-benzotriazol-2-yl)-6-(1,1-dimethylethyl)-4-methylphenol (Viosorb® 550), n-octyl-3-[3-tert-butyl-4-hydroxy-5-(5-chloro-2H-benzotriazol-2-yl) phenyl]propionate (Eversorb® 109), 2-(2-hydroxy-5-methoxyphenyl)benzotriazole, 2-(2-hydroxy-5-butoxyphenyl)benzotriazole and also Tinuvin®CarboProtect® from BASF. Preferred absorbers are of the benzotriazole family. Other examples of benzotriazole UV absorbers protecting from blue light can be found in WO 2017/137372.

The amount of UV absorber compounds according to the invention used herein is an amount sufficient to provide a satisfactory protection from UV light but not excessive so as to prevent precipitation. The inventive UV absorber compounds are generally present in an amount ranging from 0.05 to 4% by weight relative to the optical material total weight (or per 100 parts by weight of the polymerizable compounds present in the mixture of components A and B or relative to the weight of the optical material composition), preferably from 0.1 to 3% by weight, more preferably from 0.1 to 2% by weight.

Among the release agents that may be used in the invention, there may be cited mono and dialkyl phosphates, alkyl ester phosphates, silicones, fluorinated hydrocarbon, fatty acids and ammonium salts. The preferred release agents are mono and dialkyl phosphates, alkyl ester phosphates and mixtures thereof. Such release agents are disclosed inter alia in U.S. Pat. No. 4,975,328 and EP 271839. The release agent is preferably used in an amount lower than or equal to 1% by weight based on the total weight of the polymerizable compounds present in the mixture of components A and B.

The polymerizable mixture of the present invention can comprise a solvent for promoting the dissolution of the catalyst, especially if it is under the form of a salt.

Any polar organic solvent can be used such as acetonitrile, tetrahydrofuran, dioxane, ethanol, thioethanol, acetone, and 3-methyl-2-butene-1-ol. The amount of solvent is generally kept below 2% by weight, based on the total weight of the polymerizable compounds present in the mixture of components A and B and preferably from 0 to 0.5% by weight, to avoid haze and bubbling.

In the present invention, at least one latent catalyst that is heat-activatable is added in the process prior to curing step 4), and said catalyst is subsequently activated to accelerate the polymerization reaction forming the polythiourethane based transparent substrate.

The catalyst is a system for accelerating the polymerization reaction. The catalyst can comprise one or more latent thermal catalysts. The catalyst used in the present process is in fact a precatalyst that leads to the active catalyst upon activation.

The catalyst shall be used in the polymerizable composition in an effective amount, i.e., an amount sufficient to promote the polymerization of the mixture. Generally, the at least one catalyst is used in a proportion of 0.01 to 5% by weight with respect to the total weight of polymerizable compounds present in the mixture of components A and B, more preferably from 0.02 to 2%.

As used herein, a latent catalyst, or blocked/protected/triggerable catalyst, is a catalyst that displays a delayed action. The latent catalyst will not display a significant catalytic effect, i.e., will not significantly react with active SH, NCO and/or NCX groups until activated. In the present invention, the latent catalyst can be activated by heat and/or radiation, depending on its nature.

The latent catalyst according to the invention generally displays a pot life that is significantly greater that the pot life of conventional non latent catalysts or the pot life of said latent catalyst once activated. For example, said pot life is of 1 day or more and is preferably of 2 days or more.

The catalyst is generally activated during curing step 4). If the catalyst was activated during the mixing step 3), the pot life of the mixture would be shortened. The mixture would become too viscous too soon and the molds might not be filed properly.

The latent catalyst that is heat-activatable, is preferably activated by heating at a temperature of at least 40° C., preferably at least 60° C., more preferably at least 80, 100 or 120° C. It is generally inactive at room temperature (20° C.) and will not significantly react until reaching its de-blocking temperature.

The latent catalyst can be added at different stages of the present process.

In one embodiment, the catalyst is added to the polythiol and polyisocyanate or polyisothiocyanate monomers during the preparation of the polythiourethane pre-polymer A1 having isocyanate or isothiocyanate end groups or to the polythiol and polyisocyanate or polyisothiocyanate monomers during the preparation of the polythiourethane pre-polymer B1 having thiol end groups, or to the polyisocyanate or polyisothiocyanate monomers during the preparation of component A, or to the polythiol monomers during the preparation of component B, depending on the case.

In this embodiment, the latent catalyst that is heat-activatable, has an activation temperature that should be higher than the oligomerization temperature used for forming pre-polymer A1 or pre-polymer B1, depending on the case. Otherwise, the catalyst could be activated in a too early stage during the polythiourethane pre-polymer preparation and the pot life of the mixture would be shortened.

In this embodiment, it is preferred to work under conditions that do not allow activation of the latent catalyst that is heat-activatable according to the invention, such as at a temperature lower than the activation temperature, for example at room temperature if the monomers are sufficiently reactive to form the pre-polymer at this temperature.

In a preferred embodiment, the catalyst is added to the first component A obtained in step 1) prior to mixture with component B or to the second component B obtained in step 2) prior to mixture with component A. In this embodiment, the catalyst is added to pre-polymers A1 and/or B1 after their preparation, depending on the case.

In another preferred embodiment, the catalyst is added to the mixture of components A and B in step 3) of the present process.

In one embodiment, the catalyst is a latent catalyst selected from a protected amine and an ammonium salt, wherein the active form of the catalyst is an amine.

The protected amine comprises one or more covalent bond that can be broken when heating the latent catalyst, thus releasing the amine active form of the catalyst. The amine is preferably protected by at least one isocyanate compound, more preferably two.

The anion of said ammonium salt can be the anion of an acid such as a boron compound or a carboxylic acid. The ionic bond can be broken upon heating to regenerate the amine active form of the catalyst.

The amine generated by heating the latent catalyst is preferably chosen from amidines, guanidines, and fused or bridged bicyclic amines wherein at least one of the bridgehead atoms is a nitrogen atom such as a fused or bridged bicyclic diamine having one or two nitrogen bridgehead atoms, more preferably from amidines and guanidines. Said amine is more preferably an amine such as 1,5-diazabicyclo[4.3.0]non-5-ene (DBN), 1,8-diazabicyclo[5.4.0]undec-7-ene (DBU), 1,4-diazabicyclo[2.2.2]octane (DABCO) or a 1,5,7-triazabicyclo[4.4.0]dec-5-ene (TBD) compound such as a 7-alkyl-1,5,7-triazabicyclo[4.4.0]dec-5-ene, in particular 7-methyl-1,5,7-triazabicyclo [4.4.0]dec-5-ene.

It is well-known to those skilled in the art that aromatic heterocyclic compounds containing nitrogen, such as imidazoles or pyrazoles, are not amines. Preferably, the amine generated by heating the latent catalyst has a pKa ranging from 8 to 14.

For example, the catalyst may be a latent catalyst obtained from the reaction of an amine and an isocyanate compound such as a polyisocyanate or an acid (such as a carboxylic acid), preferably an amine selected from amidines, guanidines, and fused or bridged bicyclic amines wherein at least one of the bridgehead atoms is a nitrogen atom such as a bridged bicyclic diamine having one or two nitrogen bridgehead atoms. More preferably, the amine is 1,5-diazabicyclo[4.3.0]non-5-ene (DBN), 1,8-diazabicyclo[5.4.0]undec-7-ene (DBU), 1,4-diazabicyclo[2.2.2]octane (DABCO) or a 1,5,7-triazabicyclo[4.4.0]dec-5-ene (TBD) compound such as a 7-alkyl-1,5,7-triazabicyclo[4.4.0]dec-5-ene, n particular 7-methyl-1,5,7-triazabicyclo[4.4.0]dec-5-ene. Preferably, the latent catalyst is obtained from the reaction of two isocyanates and 1,5-diazabicyclo[4.3.0]non-5-ene (DBN).

In one embodiment, the catalyst is a latent catalyst obtained from the reaction of two identical or different isocyanates, preferably arylisocyanates, with 1,5-diazabicyclo[4.3.0]non-5-ene (DBN), 1,8-diazabicyclo[5.4.0]undec-7-ene (DBU) or a 1,5,7-triazabicyclo[4.4.0]dec-5-ene (TBD) compound such as 7-methyl-1,5,7-triazabicyclo[4.4.0]dec-5-ene. Without wishing to be bound by any theory, this isocyanate capping reaction generates an isocyanurate derivative precatalyst or blocked catalyst, which reversibly regenerate the active form of the catalyst (DBN, DBU or 1,5,7-triazabicyclo[4.4.0]dec-5-ene compound) upon heating. Depending on the nature of the aryl groups of the arylisocyanate blocking component, the activation temperature of the latent catalyst ranges from 40° C. to 120° C. It is generally higher than or equal to 40, 60, 80, 100, or 120° C.

In the present application, the term “aryl” denotes an aromatic monovalent carbocyclic radical comprising only one ring (for example a phenyl group) or several fused rings (for example naphthyl or terphenyl groups), which may optionally be substituted with one or more groups such as, without limitation, alkyl (for example methyl), hydroxyalkyl, aminoalkyl, hydroxyl, thiol, amino, halo (fluoro, bromo, iodo or chloro), nitro, alkylthio, alkoxy (for example methoxy), aryloxy, monoalkylamino, dialkylamino, acyl, carboxyl, alkoxycarbonyl, aryloxycarbonyl, hydroxysulfonyl, alkoxysulfonyl, aryloxysulfonyl, alkylsulfonyl, alkylsulfinyl, cyano, trifluoromethyl, tetrazolyl, carbamoyl, alkylcarbamoyl or dialkylcarbamoyl groups. Alternatively, two adjacent positions of the aromatic ring may be substituted with a methylenedioxy or ethylenedioxy group.

Non-limiting examples of suitable arylisocyanates, of formula R²—NCO with R²=aryl, are phenylisocyanate and 4-fluorophenylisocyanate.

In one embodiment, this DBN-based latent catalyst is used in combination with a co-catalyst such as a standard alkyltin catalyst (such as dibutyltin dilaurate), in a molar ratio latent catalyst/alkyltin catalyst preferably higher than or equal to 40/1, more preferably higher than or equal to 50/1.

In another embodiment, the catalyst is a latent catalyst obtained from the reaction of an organic carboxylic acid with 1,8-diazabicyclo[5.4.0]undec-7-ene (DBU), 1,5-diazabicyclo[4.3.0]non-5-ene (DBN) or a 1,5,7-triazabicyclo[4.4.0]dec-5-ene (TBD) compound such as 7-methyl-1,5,7-triazabicyclo[4.4.0]dec-5-ene. Without wishing to be bound by any theory, this reaction generates a DBU salt that is catalytically inactive at room temperature. The organic carboxylic acid acts as a blocker to prevent DBU salt from reacting until it is activated by heating, which decomposes the salt to regenerate DBU.

Depending on the nature of the organic carboxylic acid blocking component, the activation temperature of the latent catalyst is higher than or equal to 60, 80, 100, 120 or 130° C.

The organic carboxylic acid can be selected, without limitation, from acetic acid, cyanoacetic acid, malonic acid, acrylic acid, arylcarboxylic acids such as benzoic acid, preferably benzoic acid. “Aryl” has been defined above.

In another embodiment, the catalyst is a latent catalyst obtained from the reaction of a 7-alkyl-1,5,7-triazabicyclo[4.4.0]dec-5-ene (guanidine compound of formula (I)) with two identical or different alkylisocyanates or arylalkylisocyanates of formula R²—NCO with R²=alkyl or arylalkyl. Without wishing to be bound by any theory, this NCO capping reaction generates bench stable isocyanurate derivative precatalyst of formula (II), which leads to the active form of the catalyst upon heating:

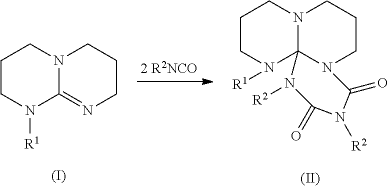

Depending on the nature of the alkylisocyanate or arylalkylisocyanate blocking component, the activation temperature of this thermal latent catalyst is higher than or equal to 40, 60 or 80° C.

In the present patent application, the term “alkyl” means a linear or branched, saturated or unsaturated hydrocarbon-based radical, containing from 1 to 25 carbon atoms, especially including acyclic groups containing from 1 to 8 carbon atoms such as methyl, ethyl, n-propyl, isopropyl, butyl and n-hexyl groups, the cycloalkyl groups preferably containing from 3 to 7 carbon atoms, the cycloalkylmethyl groups preferably containing from 4 to 8 carbon atoms. The term “alkyl” as used herein also includes alkoxyalkyl groups such as the methoxymethyl group.

In the present patent application, the term “arylalkyl” means an alkyl group substituted with at least one aryl group, such as the trityl group (—CP₃), the benzyl group or the 4-methoxybenzyl group. it is connected to the rest of the molecule via an sp³ carbon atom.

Non-limiting examples of suitable alkylisocyanates or arylalkylisocyanates are benzylisocyanate and methylisocyanate.

Several catalysts according to the invention can be combined in the present process. In particular, two or more catalysts with different activation temperatures can be employed. In this case, a first catalyst having an activation temperature lower than that of a second catalyst can form a gel while minimizing defects, and then the second catalyst is triggered at a higher temperature to drive the polymerization to completion. Such relay catalytic systems can have the advantage of relayed heat formation during the process, hence reducing localized heat spots.

In the context of the present invention, a gel designates the reaction product of components A and B in which the conversion rate of the reactive functions is significantly high. For example, said conversion rate ranges from 50 to 80% and preferably is about 70%.

An additional catalyst that is not a latent catalyst that is heat-activatable can also be used in the context of the invention. Among additional catalysts that can be used in the method of the invention, there may be cited amines, such as tertiary amines (e.g., triethylamine or 3,5-lutidine), organometallic compounds, such as alkyltins or alkyltin oxides, in particular dibutyltin dilaurate, dibutyltin dichloride and dimethyltin dichloride, ammonium salts of acids, these salts fulfilling the condition 0.5<pKa<14. In the present application, pKa is preferably expressed at 25° C. pKa can be measured in water at standard pressure by potentiometric (pH) titration, using a glass electrode and a pH meter.

In one embodiment, the method according to the invention does not use a catalyst that is not a latent catalyst that is heat-activatable.

The mixing of first component A with second component B can be performed by any known mixing technique such as those mentioned in U.S. Pat. No. 5,973, 098. Preferably, components A and B to be mixed are added in a small reactor chamber and then mixed with a screw mixer. In one embodiment, the viscosity at 25° C. of the mixture of components A and B ranges from 0.01 Pa·s to 5 Pa·s, preferably from 0.05 Pa·s to 0.5 Pa·s, even more preferably from 0.1 Pa·s to 0.3 Pa·s.

During step 3), a molding cavity of a casting mold assembly is filled with the mixture of first and second components A and B.

More specifically, the optical material composition can be poured into the cavity of two mold parts held together using an annular closure such as a gasket or tape. Depending on the desired characteristics of the resulting optical material, degassing can be performed under reduced pressure and/or filtration can be performed under increased pressure or reduced pressure before pouring the optical material composition in the mold. After pouring the composition, the casting mold, preferably a lens casting mold, can be heated in an oven or a heating device immersed in water according to a predetermined temperature program to cure the resin in the mold. The resin molded product may be annealed if necessary.

The curing step of the mixture, which provides a transparent substrate, is performed in the presence of the catalyst according to the invention, and can be implemented using any well known polymerization technique and in particular thermal polymerization including induction and infrared heating, or radiation polymerization. The curing time of step 4) is preferably lower than 10 or 5 hours, more preferably lower than 4, 3 or 2 hours.

In step 5) of the present process, the polythiourethane transparent substrate is recovered from the mold.

Specific examples of polythiourethane resins suitable to the present invention are those marketed by the Mitsui Chemicals company as MR® series, in particular MR6®, MR7® (refractive index: 1.67), MR8® (refractive index: 1.6) resins, MR10® (refractive index: 1.67). These optical materials as well as the monomers used for their preparation are especially described in the patents U.S. Pat. Nos. 4,689,387, 4,775,733, 5,059,673, 5,087,758 and 5, 191,055.

The following examples illustrate the present invention in a more detailed, but non-limiting manner. Unless stated otherwise, all thicknesses disclosed in the present application relate to physical thicknesses.

### EXAMPLES

### Chemicals Used

Optical materials were prepared from a composition comprising polymerizable monomers, a delayed action catalyst, and Zelec UN® (CAS 3896-11-5) as a mold release agent. The monomers used in the present examples were xylylene diisocyanate (CAS 3634-83-1) and 2,3-bis((2-mercaptoethyl)thio)-1-propanethiol (CAS 131538-00-6), in order to produce the polythiourethane transparent matrix having a refractive index of 1.67.

### Example 1

Preparation of Polythiourethane Pre-Polymer A1 having Isocyanate End Groups (Component A)

In a reactor equipped with a condenser, a thermal probe and an agitator, a determined amount of the polyisocyanate monomer xylylene diisocyanate (XDI) was charged and heated up to 115° C. Then, 2,3-bis((2-mercaptoethyl)thio)-1-propanethiol was introduced and mixed with the polyisocyanate in an amount such that the molar ratio of the isocyanate functions to the thiol functions NCO/SH was 8:1. The mixture was heated for 4.5 hours. The resulting pre-polymer A1 was then cooled to around 35° C. and transferred into an appropriate drum, tapped with inert gas (nitrogen or argon) and stored in a cold room. Final pre-polymer with isocyanate end groups had a viscosity at 25° C. of about 0.1 Pa·s.

Pre-Polymer A1 was prepared without the use of catalyst.

Preparation of Polythiourethane Pre-Polymer B1 having Thiol End Groups (Component B)

In a reactor equipped with a condenser, a thermal probe and an agitator, a determined amount of the polythiol monomer 2,3-bis((2-mercaptoethyl)thio)-1-propanethiol was charged and heated up to 90° C. Then, xylylene diisocyanate was introduced and mixed with the polythiol in an amount such that the molar ratio of the thiol functions to the isocyanate functions SH/NCO was 8:1. The mixture was heated for 3 hours. The end of the reaction was indicated by temperature reaching a peak and returning to 90° C. (+/−2° C.). The resulting pre-polymer B1 was then cooled to around 35° C. and transferred into an appropriate drum, tapped with inert gas (nitrogen or argon) and stored in a cold room. Final pre-polymer with thiol end groups had a viscosity at 25° C. of about 0.5 Pa·s.

Pre-polymer B1 was prepared without the use of catalyst.

### Preparation of Latent Catalyst C1

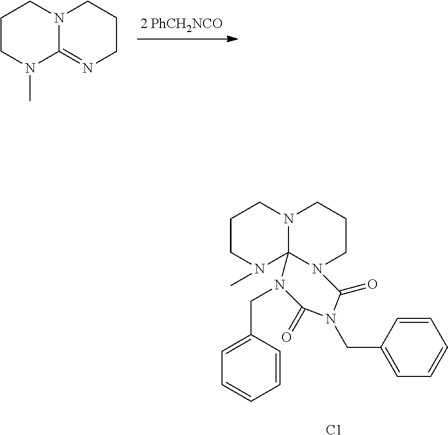 [SMILES: CN1CCCN2CCCN=C12 ; CN1CCCN2CCCN3C(=O)N(Cc4ccccc4)C(=O)N(Cc4ccccc4)C123 ; "C1"]

Guanidine compound 7-methyl-1,5,7-triazabicyclo[4.4.0]dec-5-ene (1 equivalent) was dissolved in tetrahydrofuran (THF). The mixture was then cooled to 0° C. Benzyl isocyanate (2 equivalents) was added dropwise and the mixture was stirred for 24 hours under nitrogen. The solvent was then stripped at room temperature and the solid residue was further dried under vacuum for 24 hours, affording the expected latent catalyst as a colorless solid.

### Preparation of Polythiourethane Transparent Casted Substrate

Convex and concave molds were assembled by using a tape. Center thickness was 2 mm.

Pre-polymers A1 and B1 were prepared as described above. 299.68 g of cooled down pre-polymer A1 were mixed with 0.175 g of latent catalyst C1 and 0.0480 g of Zelec UN®. This mixture was stirred at 15° C. and degassed for 1 hour to form component A. 281.57 g of pre-polymer B1 were stirred at 15° C. and degassed for 1 hour to form component B. Components A and B were then mixed in a small reactor while stirring and degassing for 5 minutes at room temperature. The resulting mixture had a viscosity at 25° C. of about 0.1 to 0.3 Pa·s. Once the mixing was complete, molds were filled with the help of a clean syringe. The assembled molds were held at room temperature for 10 minutes before inserting them in a convection oven heated at 120° C. for 3 h to carry out the polymerization reaction. The molds were then disassembled to obtain plano (no power) lenses with 2 mm center thickness comprising a body of polythiourethane transparent thermoset substrate having a refractive index of 1.67 and no optical defects such as striations. The lenses were cleaned by immersion and sonication in a surfactant solution, then rinsed and dried.

### Example 2

Similar to example 1, except that latent catalyst C2 was used instead of latent catalyst C1.

### Preparation of Latent Catalyst C2

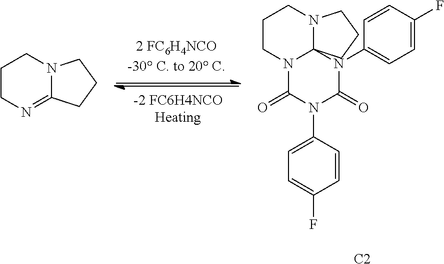 [SMILES: C1CN=C2CCCN2C1 ; O=C1N(c2ccc(F)cc2)C(=O)N(c2ccc(F)cc2)C23CCCN2CCCN13 ; "C2"]

A solution of 1,5-diazabicyclo[4.3.0]non-5-ene (DBN, 1 equivalent) in dry THF was added drop-wise to a cool solution (−10° C.) of 4-fluorophenylisocyanate (2 equivalents) in dry toluene. The mixture was stirred for 24 hours under nitrogen. The solvent was then stripped to dryness at room temperature then the solid residue was further dried under vacuum for 24 hours, affording the expected latent catalyst as a colorless solid.

### Example 3

Similar to example 1, except that latent catalyst C3 was used instead of latent catalyst C1 and that heating at 130° C. was performed during the molding step

### Preparation of Latent Catalyst C3

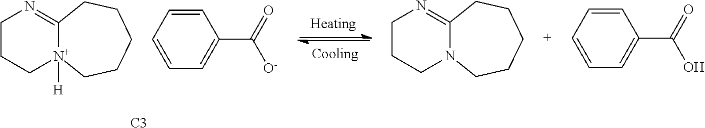 [SMILES: C1CCC2=NCCC[NH+]2CC1 ; O=C([O-])c1ccccc1 ; C1CCC2=NCCCN2CC1 ; O=C(O)c1ccccc1 ; "C3"]

Latent catalyst C3 was prepared by neutralization of 1 equivalent of 1,8-diazabicyclo[5.4.0]undec-7-ene (DBU) with 1 equivalent of benzoic acid in THF under nitrogen atmosphere. The salt quickly precipitated as a white solid, which was filtrated and washed with cold THF, then dried under vacuum for 24 hours.

1.-13. (canceled)

14. A method of fast curing a polythiourethane based transparent casted substrate, comprising the following steps 1), 2), 3), 4) and 5):
1) providing from at least one polythiol monomer and at least one polyisocyanate or polyisothiocyanate monomer a first component A comprising a polythiourethane pre-polymer Al having isocyanate or isothiocyanate end groups of formula —NCX where X is O or S;
2) providing from at least one polythiol monomer and at least one polyisocyanate or polyisothiocyanate monomer a second component B comprising a polythiourethane pre-polymer B1 having thiol end groups; or
1) providing a first component A comprising at least one polyisocyanate or polyisothiocyanate monomer;
2) providing from polythiol and polyisocyanate or polyisothiocyanate monomers a second component B comprising a polythiourethane pre-polymer B1 having thiol end groups; or
1) providing from polythiol and polyisocyanate or polyisothiocyanate monomers a first component A comprising a polythiourethane pre-polymer A1 having isocyanate or isothiocyanate end groups of formula —NCX where X is O or S;
2) providing a second component B comprising at least one polythiol monomer; and
3) mixing together first and second components A and B and filling a molding cavity of a casting mold assembly with the resulting mixture;
4) curing said mixture to obtain a polythiourethane based transparent substrate; and
5) recovering the polythiourethane based transparent substrate from the casting mold assembly;
wherein at least one latent catalyst that is heat-activatable is added in the process prior to curing step 4), and said catalyst is subsequently activated to accelerate the polymerization reaction forming the polythiourethane based transparent substrate.

15. The method of claim 14, wherein said latent catalyst is added to the polythiol and polyisocyanate or polyisothiocyanate monomers during the preparation of said polythiourethane pre-polymer A1 having isocyanate or isothiocyanate end groups or to the polythiol and polyisocyanate or polyisothiocyanate monomers during the preparation of said polythiourethane pre-polymer B1 having thiol end groups.

16. The method of claim 14, wherein said latent catalyst is added to the first component A obtained in step 1) prior to mixture with component B or to the second component B obtained in step 2) prior to mixture with component A.

17. The method of claim 14, wherein said latent catalyst is added to the mixture of components A and B in step 3).

18. The method of claim 14, wherein said latent catalyst is activated during curing step 4).

19. The method of claim 14, wherein said latent catalyst that is heat-activatable is activated by heating at a temperature of at least 40° C.

20. The method of claim 14, wherein said latent catalyst that is heat-activatable is activated by heating at a temperature of at least 60° C.

21. The method of claim 14, wherein said latent catalyst is obtained from the reaction of an amine and an isocyanate or an acid.

22. The method of claim 14, wherein said latent catalyst is obtained from the reaction of two isocyanates with 1,5-diazabicyclo[4.3.0]non-5-ene.

23. The method of claim 14, wherein said latent catalyst is obtained from the reaction of an organic carboxylic acid with 1,8-diazabicyclo[5.4.0]undec-7-ene.

24. The method of claim 14, wherein said latent catalyst is obtained from the reaction of a 7-alkyl-1,5,7-triazabicyclo[4.4.0]dec-5-ene with two alkylisocyanates or two arylalkylisocyanates.

25. The method of claim 14, wherein the curing time of step 4) is lower than 10 hours.

26. The method of claim 14, wherein the curing time of step 4) is lower than 5 hours.

27. The method of claim 14, wherein the amounts of polyisocyanate or polyisothiocyanate monomers and polythiol monomers are adapted so that the molar ratio of NCX/SH groups for the mixture of polyisocyanate or polyisothiocyanate monomers and polythiol monomers ranges from 3:1 to 30:1 for the preparation of polythiourethane pre-polymer A1 and/or the molar ratio of SH/NCX groups for the mixture of polyisocyanate or polyisothiocyanate monomers and polythiol monomers ranges from 3:1 to 30:1 for the preparation of polythiourethane pre-polymer B1, X being O or S.

28. The method of claim 14, wherein the substrate is an optical lens substrate.
